(19) United States
(12) Patent Application Publication
(10) Pub. No.: US 2021/0387882 A1
(43) Pub. Date: Dec. 16, 2021

(54) Method for Carrying out Whole-Process Treatment on Phytoplankton

(71) Applicant: CHINESE RESEARCH ACADEMY OF ENVIRONMENTAL SCIENCES, Beijing (CN)

(72) Inventors: Lieyu Zhang, Beijing (CN); Qiuheng Zhu, Beijing (CN); Wei Li, Beijing (CN); Guowen Li, Beijing (CN); Xiaoguang Li, Beijing (CN); Caole Li, Beijing (CN); Jiaqian Li, Beijing (CN); Lulu Che, Beijing (CN); Chen Zhao, Beijing (CN)

(21) Appl. No.: 17/281,040

(22) PCT Filed: Sep. 15, 2020
(86) PCT No.: PCT/CN2020/115348

§ 371 Date: Mar. 29, 2021

(30) Foreign Application Priority Data
Sep. 29, 2019 (CN) 2019109312317

(51) Int. Cl. C02F 9/00

(52) U.S. Cl. CPC C02F 9/00; C02F 1/001

(57) ABSTRACT

The present invention relates to the field of water environment treatment, and particularly discloses a method for carrying out whole-process treatment on phytoplankton. The method comprises: enabling a water body in the natural environment to first pass through a filtering device to remove large-sized particles in the water body; enabling the filtered water body to pass through a water pipe provided with multiple stages of permanent magnets to be subjected to pre-magnetization; then enabling the water body subjected to pre-magnetization to enter an equalization tank to be subjected to homogenization and/or flocculating sedimentation to separate phytoplankton and suspended particles in the water body; then for different growth phases of the phytoplankton, applying different magnetic field intensities for inhibiting and even directly killing the phytoplankton to implement optimization of cost and effects; and finally, carrying out aeration oxygenation on the magnetized water body and releasing the water body subjected to aeration oxygenation into the natural water environment.

### TECHNICAL FIELD

The present invention relates to the field of water environment treatment, and more particularly, to a method for carrying out whole-process treatment on phytoplankton.

### BACKGROUND

Due to the mass reproduction of phytoplankton, dissolved oxygen in a water body is reduced to cause the death of other aquatic organisms, resulting in an obstructed and damaged aquatic ecosystem and water functions. When the phytoplankton multiplies to a certain number, phenomena of odor emission, reduction of the transparency of the water body, reduction of dissolved oxygen of the water body, release of toxic substances, shortage of domestic water for people, reduction of stability and diversity of the aquatic organisms and the like will be generated, resulting in that huge losses are brought to the utilization of water resources and the fields of drinking water, industry, agriculture and the like, the sustainable economic development is severely hindered, and the improvement of people's living standards is restricted.

There are numerous existing phytoplankton treatment technologies, including physical methods (e.g., mechanical algae removal, the addition of clay, hydraulic engineering algae control, light shading, ultrasonic waves, and the like), chemical methods (e.g., the addition of chemical agents such as copper sulfate, complex copper, chlorine dioxide and the like, a flocculating sedimentation method and a clay mineral flocculation method) and biological methods (e.g., the addition of fishes, the introduction of protozoon, the introduction of higher plants, microbial agents, and the like).

However, the above-mentioned methods also have certain defects, and for example, when the chemical agents are used for killing algae, although the algae are killed and sink into the water, nitrogen, and phosphorus are not fundamentally removed from a lake body; and sediment dredging and the like need to consume a lot of engineering costs, and endogenous pollutants cannot be fundamentally reduced. Moreover, in different seasons, the characteristics of the phytoplankton are changed a lot. In different periods, the characteristics and existence interfaces of the phytoplankton are different, and thus, one single treatment method often has poor effects.

Therefore, most of the physical and chemical methods can only be used as emergency measures, and not only cannot eliminate the problems, but also can generate a large impact to the water ecosystem to cause collapse of the water ecosystem. The biological methods currently mainly utilize the principle of an ecological chain to carry out algae removal and treatment, but currently cannot achieve ideal effects.

Moreover, most of those methods above aim at the phytoplankton in a growth period and algae in a decline period, the algae have the common characteristic that the algae are in floating-up water. However, in practice, a great amount of algae that are dormant in upper sediments in forms of spores and the like are the reason of causing repeated occurrence and difficulty in elimination of the phytoplankton problem.

### SUMMARY

The present invention is to provide a method for carrying out whole-process treatment on phytoplankton to solve at least one technical problem existing in the prior art.

In order to fulfill the objective of the present invention, the technical solution of the present invention is as follows:

in the first aspect, the present invention provides a method for carrying out whole-process treatment on phytoplankton, and the method comprises the following steps:

enabling a water body in the natural environment to pass through a filtering device by utilizing a water pump to remove large-sized particles in the water body;

enabling the filtered water body to pass through a water pipe provided with multiple stages of permanent magnets to be subjected to pre-magnetization;

pouring the water body subjected to pre-magnetization treatment into an equalization tank to be subjected to homogenization and/or flocculating sedimentation to separate phytoplankton and suspended particles in the water body; and

carrying out magnetization on the water body treated in step (3) by magnetizers, carrying out aeration oxygenation on the magnetized water body to maintain dissolved oxygen concentration of the water body within a range of 15 to 20 mg/L, and releasing the water body subjected to aeration oxygenation into the natural water environment through a water distributing pipe.

Further, before the method is implemented, site actual survey is carried out on the to-be-treated water body, and by measuring chlorophyll content of the water body, a water temperature and water quality indexes (e.g., TN, TP, COD, and SS), in one aspect, a eutrophication degree and the number of the phytoplankton in the water body are determined to determine whether a flocculant needs to be used in step (3) and determine a dosage of the flocculant, and in the other aspect, a growth phase of the phytoplankton is determined to determine a magnetization intensity and magnetization time in step (4).

Specifically, it is that:

content of the phytoplankton in the water body is determined according to the content of chlorophyll a, and the eutrophication degree includes light eutrophication (chl-a is smaller than 26 mg/m³), moderate eutrophication (chl-a is greater than 26 mg/m³ and smaller than 64 mg/m³) and heavy eutrophication (chl-a is greater than 64 mg/m³). According to the content of the chlorophyll a, it is determined whether the water body needs to be subjected to pretreatment to avoid reduction of a subsequent magnetization effect, which is caused by the excessive biomass of algae, and the flocculant and the dosage thereof can be determined according to the biomass of the algae to avoid secondary pollution to the water body, which is caused by the excessive flocculant.

When chl-a is greater than or equal to 26 mg/m³, the flocculant is adopted in step (3) to carry out flocculating sedimentation; and when chl-a is smaller than 26 mg/m³, there is no need to adopt the flocculant in step (3) to carry out flocculating sedimentation, and only homogenization is carried out on the water body.

The homogenization specifically is that a river and lake water body is lifted into the equalization tank by the water pump, the water body is homogenized by a stirrer, and the particles and the like are separated under the action of gravity.

The flocculant adopts PAC with little influence on the environment; TP in the eutrophic water body is a restrictive factor, and thus, the TP in the water body is used as the calculation basis of the PAC; and a specific adding coefficient is 1.5.

According to the temperature of the water body, the growth phase of the phytoplankton is divided into a dormancy period (0 DEG C. to 5 DEG C.), a recovery period (5 DEG C. to 15 DEG C.), and a growth period (over 15 DEG C.).

Preferably, the step (4) of the present invention, for different growth phases of the phytoplankton, different magnetic field intensities are applied for inhibiting and even directly killing the phytoplankton to implement optimization of cost and effects. Specifically, for the water body with the phytoplankton of which the growth phase is determined as the recovery period, a magnetic field with an intensity of 150 mT to 500 mT is applied for 1 to 5 min; and for the water body with the phytoplankton of which the growth phase is determined as the dormancy period and the growth period, a magnetic field with an intensity of 500 mT to 1,000 mT is applied for 5 to 20 min.

The dormancy period (0 DEG C. to 5 DEG C.): the dormancy period of the phytoplankton generally is in autumn and winter. The phytoplankton at the moment can be positioned on the sediment surface in response to a low-temperature environment, and generate chlamydospore for dormant wintering. At the moment, cells of the phytoplankton are in a dormant state, and resistance to stress of an external environment is high. Therefore, the phytoplankton is induced by the magnetized water to which the high-intensity magnetic field is applied, which is mainly reflected in the following aspects that: (1) the high-intensity magnetic field can penetrate cell walls of the spores and directly influence metabolism in the spores; (2) transcription and expression of gvpA and gvpC genes are inhibited by magnetization induction to reduce generation of GvpA and GvpC proteins, while the GvpA and GvpC proteins are main structures of gas vesicles, and thus, formation of the gas vesicles of the phytoplankton can be effectively inhibited by utilizing a magnetized water technology to inhibit the phytoplankton from floating up to carry out photosynthesis; and (3) macro water molecules are magnetized to form micro molecule water, the micro molecule water not only improves solubility of nutrient substances, but also can more easily penetrate cytomembrane to bring a great amount of nutrient substances into the cells of the phytoplankton to carry out metabolism, and more starch substances are generated to make the dead weight of the phytoplankton much higher than a buoyancy of the phytoplankton.

The recovery period (5 DEG C. to 15 DEG C.): the recovery period generally is in early spring. At the moment, after long-time dormancy, the phytoplankton is slow in growth and metabolism, is in the weakest period and has low resistance to external interference. At the moment, the water body can be magnetized under a low-intensity magnetic field to directly inhibit and even kill the phytoplankton.

The growth period (over 15 DEG C.): at the moment, the growth metabolic activity of the phytoplankton is optimal, and the phytoplankton has a high metabolic activity and thus has high resistance to the stress of the external environment. The high-intensity magnetized water can directly act on a PSII photosynthetic system of the phytoplankton to inhibit the enzymatic activity of the phytoplankton to effectively inhibit outbreak of the phytoplankton.

Further, different water bodies include different components which include ingredients of salt, alkali, acid, suspended matter, metal elements, non-metallic elements and the like, resulting in a large difference in magnetic effect, and thus, magnetization parameters need to be properly regulated according to site water quality and the treatment objective.

When the magnetization is carried out on the water body with the phytoplankton in the recovery period, a magnetic field intensity is regulated according to TP content based on an original magnetic field intensity. When the TP is greater than or equal to 0.02 mg/L, a magnetic field with an intensity of 300 mT to 500 mT can be applied to reinforce a removal effect on the TP.

When the magnetization is carried out on the water body with the phytoplankton in the dormancy period or the growth period, the magnetic field intensity is regulated within an original magnetic field range, and when the TP is greater than or equal to 0.02 mg/L, a magnetic field with an intensity of 800 mT to 1,000 mT is applied.

Further, the filtering device in step (1) is a grille, can be specifically regulated according to site situations, has specifications of a rake tooth grille gap of 5 mm to 50 mm and the like, and has an installation angle of 60° to 70°, a maximum water passing flow rate of greater than or equal to 160 m³/h and a maximum liquid flow rate of greater than or equal to 0.3 m/s. The filtering device is mainly used for removing large-particle rubbish, plant and animal residues and large-sized phytoplankton in natural water bodies such as rivers and lakes to reduce the load of a subsequent treatment process and avoid damage to subsequent process equipment, which is caused by excessive impurities.

Further, the water pump in step (1) is a submersible pump and can be set according to a site water body treatment flow rate, and in order to meet an ectopic treatment mode, the used submersible pump should have a lift of greater than or equal to 10 m and a maximum flow rate of greater than or equal to 160 m³/h.

Further, the type of the permanent magnets in step (2) is rare earth neodymium iron boron.

The water pipe preferably has a diameter of 100 mm to 200 mm and a length of over 5 m and can be regulated according to actual situations, and by arranging one permanent magnetic type magnetizer at intervals of 10 cm to 50 cm, multi-stage magnetization is implemented, a magnetization effect on the water body is reinforced, and magnetization time is prolonged.

Pre-magnetization is carried out on the river and lake water body by the permanent magnets, and by pre-magnetization, in one aspect, the water molecule structure is changed and solubility of the flocculant is increased to reduce the dosage of the flocculant, reduce the influence on the environment and also save the cost, and in the other aspect, the magnetization time is prolonged, the magnetization effect is reinforced, and the magnetic effect retention time is prolonged.

Further, the volume of the equalization tank in step (3) can be set according to a specific water body treatment capacity.

Further, in step (4), after the water body is subjected to magnetization treatment, the phytoplankton is induced by the magnetized water. The growth metabolism of the phytoplankton can then be severely inhibited to cause the death of a great amount of phytoplankton, resulting in that the dissolved oxygen level of the water body is suddenly reduced. After the water body is subjected to aeration oxygenation, reduction of the dissolved oxygen level can be effectively prevented, and damage to water ecology can be avoided. Aeration oxygenation adopted in the present invention is that the water body is filled with pure oxygen, and dissolved oxygen content of the water body is improved by a hydration reaction, wherein an oxygen source of an aeration system adopts oxygen production equipment (PSA) to produce oxygen.

The water body subjected to aeration oxygenation is released into the natural water environment through the water distributing pipe, and a water outlet position of the water distributing pipe is set according to the growth phase of the phytoplankton, i.e., when the phytoplankton is in the dormancy period and the recovery period, a great amount of phytoplankton exists on the upper layer of sediments, and thus, outlet water is uniformly distributed at a mud-water interface by the water distributing pipe; and when the phytoplankton is in the growth period, the outlet water is uniformly distributed in floating-up water by the water distributing pipe.

In order to implement the method for carrying out whole-process treatment on phytoplankton according to the present invention, the present invention further provides a system for carrying out whole-process treatment on phytoplankton, which comprises a water pump, a filtering device, a water pipe provided with multiple stages of permanent magnetic type magnetizers, an equalization tank, the magnetizers, an aeration oxygenation device and a water distributing pipe (a water outlet pipe) which are sequentially arranged.

In some embodiments, the aeration oxygenation device adopts a pure oxygen and flow mixing aeration system, and comprises a pure oxygen producer, a water pump and a flow mixer, wherein by the flow mixer, pure oxygen and the water body are sufficiently mixed, and water body exchange of the river and lake natural water body is improved.

In summary, in the present invention, for different growth phases of the phytoplankton, different magnetic field intensities are applied for inhibiting and even directly killing the phytoplankton to implement optimization of the cost and the effects, and the specific technical steps are as follows: 1, site actual survey site is carried out, and by actually measuring a chlorophyll index of the water body, the water temperature and the water quality indexes, in one aspect, the number of the phytoplankton in the natural water body and water quality are determined to determine whether a flocculating sedimentation tank is required to carry out pretreatment and determine the dosage of the flocculant, and in the other aspect, the growth phase of the phytoplankton is determined to determine the magnetization intensity and time; 2, the water body is lifted to the filtering device by the water pump to remove large particles such as plant and animal residues, rubbish and the like in the water body to avoid influence on the subsequent process; 3, after the large-sized particles in the water body passing through the filtering device are removed, pre-magnetization is carried out on the water body by the water pipe provided with multiple stages of permanent magnets; 4, the water body is lifted into the equalization tank, in one aspect, water quality regulation is carried out to make the water quality more homogeneous, and in the other aspect, the flocculant is added according to the index of the chlorophyll a, so that the phytoplankton and the suspended particles are separated under the action of the gravity after being flocculated into aggregates; 5, the water body enters magnetizer devices to be magnetized after preorder treatment, the water body takes the motion of cutting magnetic lines in the magnetic field, hydrogen bonds, the Van der Waals force and the like of water molecules are also changed under the action of the magnetic field, which includes changes of a bond length and a bond angle of the hydrogen bonds, to change physical and chemical properties of the water body, such as transparency, a surface tension of the water body, solubility and the like, macro associated water molecule groups are changed into micro molecule groups and even single water molecules, different magnetic field parameters are regulated according to different phases of the phytoplankton, and nutrient substance absorption of organisms, the biological enzyme activity, photosynthesis and the like can be directly influenced, so that the magnetized water has an effect of inhibiting growth of the algae; 6, in order to avoid a case that after magnetization, the phytoplankton rots to consume a great amount of dissolved oxygen to make the water body black and odorous, the magnetized water body is oxygenated by aeration oxygenation equipment to improve the dissolved oxygen level of the water body; and 7, the water body is uniformly distributed in a river channel by the water outlet pipe and the water distributing pipe after aeration oxygenation, and water body exchange of the river channel is reinforced.

Raw materials involved in the present invention are all common commercial products, and operations involved in the present invention are all conventional operations in the art, unless otherwise specifically illustrated.

On the basis of the general knowledge in the art, the above-mentioned preferred conditions can be combined with each other to obtain specific embodiments.

The present invention has the advantageous effects that:

according to the present invention, by determining a magnetization solution on the basis of each growth phase of the phytoplankton, efficient phytoplankton growth whole-process treatment is implemented. In one aspect, growth, metabolism and reproduction of the phytoplankton in different growth phases are inhibited by a biomagnetic effect generated by the magnetized water, thereby inhibiting the number of the phytoplankton in the water body. In the other aspect, the buoyancy of the phytoplankton is reduced by inhibiting the formation of the gas vesicles of the phytoplankton to reduce the photosynthesis level of the phytoplankton, thereby achieving an effect of inhibiting the phytoplankton.

When the phytoplankton is inhibited and even killed by utilizing the magnetized water technology, increase of later oxygen consumption of the water body may be caused, and thus, the water body is oxygenated by combining with the aeration oxygenation equipment to provide oxygen for later death decomposition of the phytoplankton to avoid the oxygen deficit of the water body, which is caused by the rot of the phytoplankton. Therefore, the present invention provides the reliable, effective, and low-cost treatment method and technology for the whole process from the growth of the phytoplankton to dormancy of the phytoplankton.

### DETAILED DESCRIPTION

Preferred embodiments of the present invention will be illustrated in detail below in connection with embodiments. It should be understood that embodiments given below are merely used for illustration, rather than limiting the scope of the present invention. Those of ordinary skill in the art, without departing from the purpose and the spirit of the present invention, can make various modifications and replacements to the present invention.

Experimental methods used in the below-mentioned embodiments, unless otherwise specifically illustrated, are all conventional methods.

Materials, reagents and the like used in the below-mentioned embodiments, unless otherwise specifically illustrated, all can be obtained by commercial approaches.

### Embodiment 1

This embodiment is used for illustrating a system for carrying out whole-process treatment on phytoplankton, which comprises the following devices: a submersible pump, a coarse grille, a water inlet pipe provided with permanent magnets, an equalization tank, magnetization equipment, aeration oxygenation equipment, and a water distributing pipe which are sequentially connected.

Wherein, the submersible pump has a lift of 15 m and a power of 160 m³/h.

Wherein, the coarse grille has a grille gap of 40 mm and an installation angle of 60°.

Wherein, the water inlet pipe has a diameter of 160 mm and a length of 5 m; and raw materials of the permanent magnets are rare earth neodymium iron boron.

Wherein, the equalization tank is a cuboid device, and has a size of 3.0 m*1.5 m, an available water depth of 2 m and an effective volume of 9 m³.

Wherein, the magnetization equipment has a maximum treatment capacity of 5,000 m³/d and a magnetic field range of 50 mT to 2,500 mT.

Wherein, the aeration oxygenation equipment has an oxygen production capacity of 300 Kg/d, and can produce pure oxygen with a purity of 95%.

### Embodiment 2 Treatment of Phytoplankton

This embodiment takes a heavy eutrophic rural pond water body as an example, and illustrates a method for carrying out treatment on phytoplankton by utilizing the system described in Embodiment 1.

After detection, a water temperature of the rural pond is 16 to 28 DEG C., the phytoplankton in the water body is in a growth period, chlorophyll a content of the water body reaches 78 μg/L, TP content of the water body reaches 0.33 mg/L, and the water body belongs to a heavy eutrophic water body.

The pond water body is lifted to the coarse grille by the submersible pump and passes through the coarse grille to remove large-particle rubbish, plant and animal residues and large-sized phytoplankton in the water body;

pre-magnetization is carried out on the filtered water body by the water inlet pipe provided with the permanent magnets, and a water flow rate is about 0.5 to 1.0 m/s;

the water body enters the equalization tank after being subjected to pre-magnetization treatment, homogenization is carried out by a stirrer, then a PAC flocculant is added, a dosage is 1.5 times the TP content, flocculating sedimentation is carried out on the water body, and the phytoplankton and suspended particles in the water body are separated; and

the water body subjected to flocculating sedimentation treatment is introduced into the magnetization equipment to be magnetized for 5 min under a magnetic field intensity of 800 mT, aeration oxygenation is carried out on the magnetized water body to maintain dissolved oxygen concentration of the water body within a range of 15 mg/L to 20 mg/L, and the obtained water body is discharged into the pond by the water distributing pipe.

The above-mentioned treatment is continued for 10d, Chl-a, TP and TN of the water body in the pond are monitored, algae cells in surface layer sediments (3 cm) are counted by utilizing a microscope, and a result is as shown in Table 1:

TABLE 1

| | Change Rate | Change | Change | Change | Change |
|---|---|---|---|---|---|
| | (%) of Number | Rate | Rate | Rate | Rate |
| Treatment | of Algae Cells | (%) of | (%) of | (%) of | (%) of |
| Time | in Sediments | Chl-a | TP | TN | BOD |
| 0 d | 0 | 0 | 0 | 0 | 0 |
| 10 d | −21.2 | −81.3 | −45.7 | −44.2 | −71.2 |

### Contrast Example 1

In order to research influence of magnetization treatment carried out on the water body on phytoplankton in different growth phases, this contrast example respectively adopts magnetization treatment and non-magnetization treatment (after passing through the equalization tank, the water body does not enter the magnetization equipment to be magnetized) in different growth phases of algae, after 10d, removal rates of chlorophyll a, TP, TN, BOD and COD in the water body are compared, and specific test indexes in the algae dormancy period, the algae recovery period and the algae growth period are respectively as shown in Table 2, Table 3 and Table 4.

TABLE 2
Comparison of Indexes in Algae Dormancy Period

| | | | | | | | | Change |
|---|---|---|---|---|---|---|---|---|
| | | Magnetic | Change | Change | Change | Change | Change | Rate (%) |
| | | Field | Rate | Rate | Rate | Rate | Rate | of Number |
| | Whether to | Intensity | (%) of | (%) of | (%) of | (%) of | (%) of | of Algae in |
| Period | Magnetize | (mT) | Chl-a | TP | TN | BOD | COD | Sediments |
| Algae | No | 0 | 0 | 0 | 0 | 0 | 0 | 0 |
| Dormancy | | | | | | | | |
| Period | | | | | | | | |
| Algae | Yes | 150 | −32.9 | −51.2 | −15.2 | −49.3 | −41.2 | −10.1 |
| Dormancy | | | | | | | | |
| Period | | | | | | | | |
| Algae | Yes | 300 | −49.7 | −59.2 | −15.2 | −54.2 | −47.3 | −11.2 |
| Dormancy | | | | | | | | |
| Period | | | | | | | | |
| Algae | Yes | 500 | −62.3 | −64.1 | −17.3 | −66.2 | −61.8 | −29.7 |
| Dormancy | | | | | | | | |
| Period | | | | | | | | |
| Algae | Yes | 800 | −67.2 | −69.4 | −21.4 | −74.3 | −67.2 | −44.1 |
| Dormancy | | | | | | | | |
| Period | | | | | | | | |
| Algae | Yes | 1,000 | −66.7 | −77.8 | −21.9 | −77.3 | −65.7 | −43.7 |
| Dormancy | | | | | | | | |
| Period | | | | | | | | |

It can be known from Table 2 that in the algae dormancy period, a magnetic field intensity of 500 to 1,000 mT is the most effective for water quality improvement and removal of the algae on the surface layer of the sediments.

TABLE 3
Comparison of Indexes in Algae Recovery Period

| | | | | | | | | Change |
|---|---|---|---|---|---|---|---|---|
| | | Magnetic | Change | Change | Change | Change | Change | Rate (%) |
| | | Field | Rate | Rate | Rate | Rate | Rate | of Number |
| | Whether to | Intensity | (%) of | (%) of | (%) of | (%) of | (%) of | of Algae in |
| Period | Magnetize | (mT) | Chl-a | TP | TN | BOD | COD | Sediments |
| Algae | No | 0 | 0 | 0 | 0 | 0 | 0 | 0 |
| Recovery | | | | | | | | |
| Period | | | | | | | | |
| Algae | Yes | 150 | −89.3 | −69.6 | −21.3 | −71.9 | −60.2 | −17.2 |
| Recovery | | | | | | | | |
| Period | | | | | | | | |
| Algae | Yes | 300 | −94.2 | −71.2 | −24.5 | −74.9 | −61.9 | −21.4 |
| Recovery | | | | | | | | |
| Period | | | | | | | | |
| Algae | Yes | 500 | −90.7 | −71.2 | −25.1 | −73 | −61.3 | −20.2 |
| Recovery | | | | | | | | |
| Period | | | | | | | | |
| Algae | Yes | 800 | −83.1 | −65.7 | −21.9 | −68.3 | −57.6 | −17.4 |
| Recovery | | | | | | | | |
| Period | | | | | | | | |
| Algae | Yes | 1,000 | −79.3 | −61.2 | −18.1 | −63.7 | −52.4 | −18.7 |
| Recovery | | | | | | | | |
| Period | | | | | | | | |

It can be known from Table 3 that in the algae recovery period, a magnetic field intensity of 150 to 500 mT is the most effective for water quality improvement and removal of the algae on the surface layer of the sediments.

TABLE 4
Comparison of Indexes in Algae Growth Period

| | | | | | | | | Change |
|---|---|---|---|---|---|---|---|---|
| | | Magnetic | Change | Change | Change | Change | Change | Rate (%) |
| | | Field | Rate | Rate | Rate | Rate | Rate | of Number |
| | Whether to | Intensity | (%) of | (%) of | (%) of | (%) of | (%) of | of Algae in |
| Period | Magnetise | (mT) | Chl-a | TP | TN | BOD | COD | Sediments |
| Algae | No | 0 | 0 | 0 | 0 | 0 | 0 | 0 |
| Growth | | | | | | | | |
| Period | | | | | | | | |
| Algae | Yes | 150 | −68.3 | −61.3 | −20.3 | −62.3 | −50.2 | −17.3 |
| Growth | | | | | | | | |
| Period | | | | | | | | |
| Algae | Yes | 300 | −71.2 | −69.3 | −25.9 | −64.8 | −54.1 | −18.3 |
| Growth | | | | | | | | |
| Period | | | | | | | | |
| Algae | Yes | 500 | −78.3 | −73.2 | −30.4 | −69.2 | −61.2 | −21.5 |
| Growth | | | | | | | | |
| Period | | | | | | | | |
| Algae | Yes | 800 | −87.8 | −77.8 | −33.1 | −71.2 | −65.2 | −27.3 |
| Growth | | | | | | | | |
| Period | | | | | | | | |
| Algae | Yes | 1,000 | −88.3 | −80.1 | −33.1 | −70.2 | −62 | −24.1 |
| Growth | | | | | | | | |
| Period | | | | | | | | |

It can be known from Table 4 that in the algae growth period, a magnetic field intensity of 500 to 1,000 mT is the most effective for water quality improvement and removal of the algae on the surface layer of the sediments.

### Embodiment 3 Regulation and Control of Gas Vesicles

In order to carry out validation on the present invention better, according to the present invention, laboratory validation is carried out on gas vesicles, three periods of algae are simulated by regulation of a temperature of a light incubator, algae in different growth periods are respectively subjected to magnetization and non-magnetization at temperatures of 5 DEG C., 15 DEG C. and 30 DEG C., volume size changes of the gas vesicles are compared, and a result is as shown in Table 5.

TABLE 5

| | | Magnetic | | Change Rate |
|---|---|---|---|---|
| | | Field | | (%) of volume |
| | Whether to | Intensity | Magnetization | size of gas |
| Period | Magnetize | (mT) | Time (min) | vesicles |
| Algae | No | 0 | 0 | 0 |
| Dormancy | | | | |
| Period | | | | |
| Algae | Yes | 800 | 5 | 0 |
| Dormancy | | | | |
| Period | | | | |
| Algae | No | 0 | 0 | 0 |
| Recovery | | | | |
| Period | | | | |
| Algae | Yes | 300 | 1 | −69.1 |
| Recovery | | | | |
| Period | | | | |
| Algae | No | 0 | 0 | 0 |
| Growth | | | | |
| Period | | | | |
| Algae | Yes | 800 | 5 | −77.4 |
| Growth | | | | |
| Period | | | | |

Although the present invention has been described above in great detail with general descriptions and specific embodiments, on the basis of the present invention, various modifications or improvements may be made, which is apparent to those of ordinary skill in the art. Therefore, all such modifications and improvements without departing from the spirit of the present invention are within the scope of the claims of the present invention.

1. A method for carrying out whole-process treatment on phytoplankton, comprising:
enabling a water body in a natural environment to pass through a filtering device by utilizing a water pump to remove large-sized particles in the water body;
enabling the filtered water body to pass through a water pipe provided with multiple stages of permanent magnets to be subjected to pre-magnetization treatment;
pouring the water body subjected to pre-magnetization treatment into an equalization tank to be subjected to homogenization and/or flocculating sedimentation to separate phytoplankton and suspended particles in the water body; and
carrying out magnetization treatment on the water body treated by magnetizers, carrying out aeration oxygenation on the magnetized water body to maintain dissolved oxygen concentration of the water body within a range of 15 to 20 mg/L, and releasing the water body subjected to aeration oxygenation into a natural water environment through a water distributing pipe.

2. The method according to claim 1, wherein a growth phase of the phytoplankton is determined according to a temperature of the water body, and for different growth phases, different magnetic field parameters are adopted to carry out magnetization treatment,
wherein for the water body with the phytoplankton in a recovery period, a magnetic field with an intensity of 150 mT to 500 mT is applied for 1 to 5 min; and for the water body with the phytoplankton in a dormancy period or a growth period, a magnetic field with an intensity of 500 mT to 1,000 mT is applied for 5 to 20 min.

3. The method according to claim 2, wherein when magnetization treatment is carried out on the water body with the phytoplankton in the recovery period and a TP is greater than or equal to 0.02 mg/L, a magnetic field with an intensity of 300 mT to 500 mT is applied; and
when magnetization treatment is carried out on the water body with the phytoplankton in the dormancy period or the growth period and the TP is greater than or equal to 0.02 mg/L, a magnetic field with an intensity of 800 mT to 1,000 mT is applied.

4. The method according to claim 1, wherein when chlorophyll a in the water body is greater than or equal to 26 mg/m³, a flocculant PAC is added into the equalization tank, the TP in the water body is used as a calculation basis, and an adding coefficient of the PAC is 1.5.

5. The method according to claim 4, wherein the filtering device is a grille with a rake tooth grille gap of 5 mm to 50 mm.

6. The method according to claim 5, wherein the permanent magnets are made of rare earth neodymium iron boron.

7. The method according to claim 6, wherein the water body subjected to aeration oxygenation is released into the natural water environment through the water distributing pipe, and when the phytoplankton in a primitive water body is in the dormancy and the recovery periods, the water body subjected to aeration oxygenation is uniformly distributed at a mud-water interface by the water distributing pipe; and when the phytoplankton in the primitive water body is in the growth period, the water body subjected to aeration oxygenation is uniformly distributed in a floating-up water by the water distributing pipe.

8. A system for carrying out whole-process treatment on phytoplankton, comprising:
a water pump,
a filtering device,
a water pipe provided with multiple stages of permanent magnetic type magnetizers,
an equalization tank,
the permanent magnetic type magnetizers,
an aeration oxygenation device, and
a water distributing pipe which are sequentially arranged.

9. The whole-process treatment system according to claim 8, wherein the water pipe provided with multiple stages of permanent magnetic type magnetizers is formed by arranging the permanent magnetic type magnetizers at intervals of 10 to 50 cm around the water pipe.

10. The whole-process treatment system according to claim 9, wherein the magnetizers are adjustable permanent magnetic type magnetizers.
